(19) United States
(12) Patent Application Publication
(10) Pub. No.: US 2017/0190866 A1
(43) Pub. Date: Jul. 6, 2017

(54) Hydrogen Store Comprising a Hydrogenable Material and a Polymer Matrix

(71) Applicant: GKN Sinter Metals Engineering GmbH, Radevormwald (DE)

(72) Inventors: Antonio CASELLAS, Siegburg (DE); Eberhard ERNST, Eichenzell (DE); Thomas SCHUPP, Scheuerfeld (DE)

(21) Appl. No.: 15/308,746

(22) PCT Filed: May 4, 2015
(86) PCT No.: PCT/EP2015/059725

§ 371 Date: Nov. 3, 2016

(30) Foreign Application Priority Data
May 5, 2014 (DE) 10 2014 006 377.1

(51) Int. Cl. C08K 3/08; C08K 3/04; C01B 3/00

(52) U.S. Cl. CPC C08K 3/08; C01B 3/0078; C01B 3/0026; C01B 3/0031; C08K 3/04

(57) ABSTRACT

The present invention concerns a hydrogen store comprising a hydrogenable material, a method for producing the hydrogen store and a device for producing the hydrogen store.

The present invention relates to a hydrogen storage means comprising a hydrogenatable material and a polymeric matrix, to a process for producing the hydrogen storage means, and to an apparatus for producing the hydrogen storage means.

One of the major challenges in the 21st century is the provision of alternative energy sources. As is well-known, the resources of fossil energy carriers, such as mineral oil or natural gas, are limited. Hydrogen is an alternative of interest here. Hydrogen (H₂) in itself is not an energy source, but first has to be prepared with utilization of other energy sources. By contrast with power generated directly by means of solar energy, for example, hydrogen, however, can be stored and transported. Moreover, hydrogen can be converted back to energy in different ways, for example in a fuel cell or by direct combustion. The only waste product formed is water. However, a disadvantage when working with hydrogen is that it is readily combustible, and mixing with air gives rise to highly explosive hydrogen/oxygen mixtures.

Safe storage for transport or storage as well is thus a great challenge.

Hydrogen cannot easily be stored in a hydrogen storage means and then recovered, since hydrogen has the smallest molecules of all gases. US 2006/0030483 A1 describes hollow microbeads which are said to be hydrogen storage means. US 2012/0077020 A1 and US 2013/0136684 A1 disclose the use of carbon as matrix material in hydrogen storage means. The storage of hydrogen in an electrode of a battery is elucidated in DE 60 030 221 T2.

It is an object of the invention to provide a hydrogen storage means having improved properties over the prior art, especially having a prolonged lifetime.

A hydrogen storage means having the features of claim 1, a process for producing a hydrogen storage means having the features of claim 12 and an apparatus for producing a hydrogen storage means having the features of claim 14 are proposed. Advantageous features, configurations and developments will be apparent from the description which follows, the figures and also the claims, without restriction of individual features from a configuration thereto. Instead, one or more features from one configuration can be combined with one or more features of another configuration to give further configurations. More particularly, the respective independent claims can also each be combined with one another. Nor should the wording of the independent claims be regarded as a restriction of the subject matter claimed. One or more features of the claim wording can therefore be exchanged or else omitted, but may additionally also be added on. It is also possible to use the features cited with reference to a specific working example in generalized form as well, or likewise to use them in other working examples, especially applications.

The invention relates to a hydrogen storage means comprising a hydrogenatable material and a matrix into which the hydrogenatable material has been embedded, wherein the matrix comprises at least one polymer. Matrix and hydrogenatable material together form a composite material.

The term “hydrogen storage means” describes a reservoir vessel in which hydrogen can be stored. This can be done using conventional methods of saving and storage of hydrogen, for example compressed gas storage, such as storage in pressure vessels by compression with compressors, or liquefied gas storage, such as storage in liquefied form by cooling and compression. Further alternative forms of storage of hydrogen are based on solids or liquids, for example metal hydride storage means, such as storage as a chemical compound between hydrogen and a metal or an alloy, or adsorptive storage of hydrogen in highly porous materials. In addition, for storage and transport of hydrogen, there are also possible hydrogen storage means which temporarily bind the hydrogen to organic substances, giving rise to liquid compounds that can be stored at ambient pressure, called “chemically bound hydrogen”.

Hydrogen storage means may comprise, for example, metals or metal alloys which react with hydrogen to form hydrides (metal hydrides). This process of hydrogen storage is also referred to as hydrogenation and proceeds with release of heat. It is thus an exothermic reaction. The hydrogen stored in the hydrogenation can be released again in the dehydrogenation. The supply of heat is necessary here, since dehydrogenation is an endothermic reaction. A corresponding hydrogen storage means can thus have two extreme states: 1) the hydrogen storage material is fully laden with hydrogen. The material is completely in the form of its hydride; and 2) the hydrogen storage material does not store any hydrogen, and so the material takes the form of the metal or metal alloy.

The term ‘composite material’ describes a composite composed of two or more associated materials. In this case, a first material, in the present case the hydrogenatable material, is embedded into a second material, the matrix. The matrix may have open pores or else closed pores. The matrix is preferably porous. The embedding of one material into the other material can result, for example, in supplementary material properties otherwise possessed only by the individual component. In respect of the properties of the material composites, physical properties and geometry of the components are important. In particular, size effects often play a role. The bonding is effected, for example, in a cohesive or form-fitting manner or a combination of the two. In this way, for example, fixed positioning of the hydrogenatable material in the matrix can be enabled.

As well as the at least one polymer, the matrix may include one or more further components, for example materials for the conduction of heat and/or the conduction of gas.

The matrix may, in accordance with the invention, comprise one or more polymers and is therefore referred to as polymeric matrix. The matrix may therefore comprise one polymer or mixtures of two or more polymers. The matrix preferably comprises only one polymer. More particularly, the matrix itself may be hydrogen-storing. For example, it is possible to use ethylene (polyethylene, PE). Preference is given to utilizing a titanium-ethylene compound. In a preferred configuration, this can store up to 14% by weight of hydrogen.

The term “polymer” describes a chemical compound composed of chain or branched molecules, called macromolecules, which in turn consist of identical or equivalent units, called the constitutional repeat units. Synthetic polymers are generally plastics.

Through the use of at least one polymer, the matrix can impart good optical, mechanical, thermal and/or chemical properties to the material. For example, the hydrogen storage means, by virtue of the polymer, may have good thermal stability, resistance to the surrounding medium (oxidation resistance, corrosion resistance), good conductivity, good hydrogen absorption and storage capacity or other properties, for example mechanical strength, which would otherwise not be possible without the polymer. It is also possible to use polymers which, for example, do not enable storage of hydrogen but do enable high expansion, for example polyamide or polyvinyl acetates.

According to the invention, the polymer may be a homopolymer or a copolymer. Copolymers are polymers composed of two or more different types of monomer unit. Copolymers consisting of three different monomers are called terpolymers. According to the invention, the polymer, for example, may also comprise a terpolymer.

Preferably, the polymer (homopolymer) has a monomer unit which, as well as carbon and hydrogen, preferably additionally includes at least one heteroatom selected from sulfur, oxygen, nitrogen and phosphorus, such that the polymer obtained, in contrast to polyethylene, for example, is not entirely nonpolar. It is also possible for at least one halogen atom selected from chlorine, bromine, fluorine, iodine and astatine to be present. Preferably, the polymer is a copolymer and/or a terpolymer in which at least one monomer unit, in addition to carbon and hydrogen, additionally includes at least one heteroatom selected from sulfur, oxygen, nitrogen and phosphorus and/or at least one halogen atom selected from chlorine, bromine, fluorine, iodine and astatine is present. It is also possible that two or more monomer units have a corresponding heteroatom and/or halogen atom.

The polymer preferably has adhesive properties with respect to the hydrogen storage material. This means that it adheres well to the hydrogen storage material itself and hence forms a matrix having stable adhesion to the hydrogen storage material even under stresses as occur during the storage of hydrogen.

The adhesive properties of the polymer enable stable penetration of the material into a hydrogen storage means and the positioning of the material at a defined point in the hydrogen storage means over a maximum period of time, i.e. over several cycles of hydrogen storage and hydrogen release. A cycle describes the operation of a single hydrogenation and subsequent dehydrogenation. The hydrogen storage material should preferably be stable over at least 500 cycles, especially over at least 1000 cycles, in order to be able to use the material economically. “Stable” in the context of the present invention means that the amount of hydrogen which can be stored and the rate at which the hydrogen is stored, even after 500 or 1000 cycles, corresponds essentially to the values at the start of use of the hydrogen storage means. More particularly, “stable” means that the hydrogenatable material is kept at least roughly at the position within the hydrogen storage means where it was originally introduced into the storage means. “Stable” should especially be understood to the effect that no separation effects occur during the cycles, where finer particles separate and are removed from coarser particles.

The hydrogen storage material of the present invention is especially a low-temperature hydrogen storage material. In the course of hydrogen storage, which is an exothermic process, temperatures of up to 150° C. therefore occur. A polymer which is used for the matrix of a corresponding hydrogen storage material has to be stable at these temperatures. A preferred polymer therefore does not break down up to a temperature of 180° C., especially up to a temperature of 165° C., especially of up to 145° C.

More particularly, the polymer is a polymer having a melting point of 100° C. or more, especially of 105° C. or more, but less than 150° C., especially of less than 140° C., particularly of 135° C. or less. Preferably, the density of the polymer, determined according to ISO 1183 at 20° C., is 0.7 g/cm³ or more, especially 0.8 g/cm³ or more, preferably 0.9 g/cm³ or more, but not more than 1.3 g/cm³, preferably not more than 1.25 g/cm³, especially 1.20 g/cm³ or less. The tensile strength according to ISO 527 is preferably in the range from 10 MPa to 100 MPa, especially in the range from 15 MPa to 90 MPa, more preferably in the range from 15 MPa to 80 MPa. The tensile modulus of elasticity according to ISO 527 is preferably in the range from 50 MPa to 5000 MPa, especially in the range from 55 MPa to 4500 MPa, more preferably in the range from 60 MPa to 4000 MPa. It has been found that, surprisingly, polymers having these mechanical properties are particularly stable and have good processibility. More particularly, they enable stable coherence between the matrix and the hydrogenatable material embedded therein, such that the hydrogenatable material remains at the same position within the hydrogen storage means over several cycles. This enables a long lifetime of the hydrogen storage means.

More preferably, in the context of the present invention, the polymer is selected from EVA, PMMA, EEAMA and mixtures of these polymers.

EVA (ethyl vinyl acetate) refers to a group of copolymers of ethylene and vinyl acetate having a proportion of vinyl acetate in the range from 2% by weight to 50% by weight. Lower proportions of vinyl acetate lead to the formation of rigid films, whereas higher proportions lead to greater adhesiveness of the polymer. Typical EVAs are solid at room temperature and have tensile elongation of up to 750%. In addition, EVAs are resistant to stress cracking. EVA has the following general formula (I):

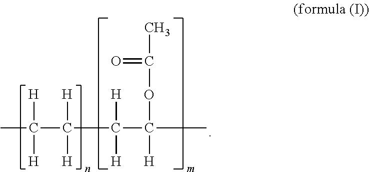

EVA in the context of the present invention preferably has a density of 0.9 g/cm³ to 1.0 g/cm³ (according to ISO 1183). Yield stress according to ISO 527 is especially 4 to 12 MPa, preferably in the range from 5 MPa to 10 MPa, particularly from 5 to 8 MPa. Especially suitable are those EVAs which have tensile strengths (according to ISO 527) of more than 12 MPa, especially more than 15 MPa, and less than 50 MPa, especially less than 40 MPa, particularly 25 MPa or less. Elongation at break (according to ISO 527) is especially >30% or >35%, particularly >40% or 45%, preferably >50%. The tensile modulus of elasticity is preferably in the range from 35 MPa to 120 MPa, particularly from 40 MPa to 100 MPa, preferably from 45 MPa to 90 MPa, especially from 50 MPa to 80 MPa. Suitable EVAs are sold, for example, by Axalta Coating Systems LLC under the Coathylene® CB 3547 trade name.

Polymethylmethacrylate (PMMA) is a synthetic transparent thermoplastic polymer having the following general structural formula (II):

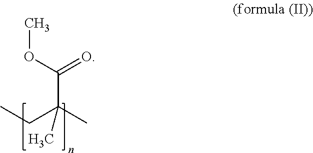

The glass transition temperature, depending on the molar mass, is about 45° C. to 130° C. The softening temperature is preferably 80° C. to 120° C., especially 90° C. to 110° C. The thermoplastic copolymer is notable for its resistance to weathering, light and UV radiation.

PMMA in the context of the present invention preferably has a density of 0.9 to 1.5 g/cm³ (according to ISO 1183), especially of 1.0 g/cm³ to 1.25 g/cm³. Especially suitable are those PMMAs which have tensile strength (according to ISO 527) of more than 30 MPa, preferably of more than 40 MPa, especially more than 50 MPa, and less than 90 MPa, especially less than 85 MPa, particularly of 80 MPa or less. Elongation at break (according to ISO 527) is especially <10%, particularly <8%, preferably <5%. The tensile modulus of elasticity is preferably in the range from 900 MPa to 5000 MPa, preferably from 1200 to 4500 MPa, especially from 2000 MPa to 4000 MPa. Suitable PMMAs are sold, for example, by Ter Hell Plastics GmbH, Bochum, Germany, under the trade name of 7M Plexiglas® pellets.

EEAMA is a terpolymer formed from ethylene, acrylic ester and maleic acid anhydride monomer units. EEAMA has a melting point of about 102° C., depending on the molar mass. It preferably has a relative density at 20° C. (DIN 53217/ISO 2811) of 1.0 g/cm³ or less and 0.85 g/cm³ or more. Suitable EEAMAs are sold, for example, under the Coathylene® TB3580 trade name by Axalta Coating Systems LLC.

Preferably, the composite material comprises essentially the hydrogen storage material and the matrix. The proportion by weight of the matrix based on the total weight of the composite material is preferably 10% by weight or less, especially 8% by weight or less, more preferably 5% by weight or less, and is preferably at least 1% by weight and especially at least 2% by weight to 3% by weight. It is desirable to minimize the proportion by weight of the matrix.

Even though the matrix is capable of storing hydrogen, the hydrogen storage capacity is not as significant as that of the hydrogen storage material itself. However, the matrix is needed in order firstly to keep any oxidation of the hydrogen storage material that occurs at a low level or prevent it entirely and to assure coherence between the particles of the material.

It is preferable that the matrix is a polymer having low crystallinity. The crystallinity of the polymer can considerably alter the properties of a material. The properties of a semicrystalline material are determined both by the crystalline and the amorphous regions of the polymer. As a result, there is a certain relationship with composite materials, which are likewise formed from two or more substances. For example, the expansion capacity of the matrix decreases with increasing density.

The matrix may also take the form of prepregs. Prepreg is the English abbreviation of “preimpregnated fibers”. Prepregs are semifinished textile products preimpregnated with a polymer, which are cured thermally and under pressure for production of components. Suitable polymers are those having a highly viscous but unpolymerized thermoset polymer matrix. The polymers preferred according to the present invention may also take the form of a prepreg.

The fibers present in the prepreg may be present as a pure unidirectional layer, as a fabric or scrim. The prepregs may, in accordance with the invention, also be comminuted and be processed as flakes or shavings together with the hydrogenatable material to give a composite material.

In one version of the present invention, the polymer may take the form of a liquid which is contacted with the hydrogenatable material. One meaning of “liquid” here is that the polymer is melted. However, the invention also encompasses dissolution of the polymer in a suitable solvent, in which case the solvent is removed again after production of the composite material, for example by evaporation. However, it is also possible that the polymer takes the form of pellets which are mixed with the hydrogenatable material. As a result of the compaction of the composite material, the polymer softens, so as to form the matrix into which the hydrogenatable material is embedded. If the polymer is used in the form of particles, i.e. of pellets, these preferably have an x₅₀ particle size (volume-based particle size) in the range from 30 μm to 60 μm, especially from 40 μm to 45 μm. The x₉₀ particle size is especially 90 μm or less, preferably 80 μm or less.

The hydrogenatable material can absorb the hydrogen and, if required, release it again. In a preferred embodiment, the material comprises particulate materials in any 3-dimensional configuration, such as particles, pellets, fibers, preferably cut fibers, flakes and/or other geometries. More particularly, the material may also take the form of sheets or powder. In this case, the material does not necessarily have a homogeneous configuration. Instead, the configuration may be regular or irregular. Particles in the context of the present invention are, for example, virtually spherical particles, and likewise particles having an irregular, angular outward shape. The surface may be smooth, but it is also possible that the surface of the material is rough and/or has unevenness and/or depressions and/or elevations. According to the invention, a hydrogen storage means may comprise the material in just one specific 3-dimensional configuration, such that all particles of the material have the same spatial extent. However, it is also possible that a hydrogen storage means comprises the material in different configurations/geometries. By virtue of a multitude of different geometries or configurations of the material, the material can be used in a multitude of different hydrogen storage means.

Preferably, the material comprises hollow bodies, for example particles having one or more cavities and/or having a hollow shape, for example a hollow fiber or an extrusion body with a hollow channel. The term “hollow fiber” describes a cylindrical fiber having one or more continuous cavities in cross section. Through the use of a hollow fiber, it is possible to combine a plurality of hollow fibers to give a hollow fiber membrane, by means of which absorption and/or release of the hydrogen from the material can be facilitated because of the high porosity.

Preferably, the hydrogenatable material has a bimodal size distribution. In this way, a higher bulk density and hence a higher density of the hydrogenatable material in the hydrogen storage means can be enabled, which increases the hydrogen storage capacity, i.e. the amount of hydrogen which can be stored in the storage means.

According to the invention, the hydrogenatable material may comprise, preferably consist of, at least one hydrogenatable metal and/or at least one hydrogenatable metal alloy.

Other hydrogenatable materials used may be:
alkaline earth metal and alkali metal alanates,
alkaline earth metal and alkali metal borohydrides,
metal-organic frameworks (MOFs) and/or
clathrates,

and, of course, respective combinations of the respective materials.

According to the invention, the material may also include non-hydrogenatable metals or metal alloys.

According to the invention, the hydrogenatable material may comprise a low-temperature hydride and/or a high-temperature hydride. The term “hydride” refers to the hydrogenatable material, irrespective of whether it is in the hydrogenated form or the non-hydrogenated form. Low-temperature hydrides store hydrogen preferably within a temperature range between −55° C. and 180° C., especially between −20° C. and 150° C., particularly between 0° C. and 140° C. High-temperature hydrides store hydrogen preferably within a temperature range of 280° C. upward, especially 300° C. upward. At the temperatures mentioned, the hydrides cannot just store hydrogen but can also release it, i.e. are able to function within these temperature ranges.

Where ‘hydrides’ are described in this context, this is understood to mean the hydrogenatable material in its hydrogenated form and also in its non-hydrogenated form. According to the invention, in the production of hydrogen storage means, it is possible to use hydrogenatable materials in their hydrogenated or non-hydrogenated form.

With regard to hydrides and their properties, reference is made in the context of the disclosure to tables 1 to 4 in S. Sakietuna et al., International Journal of Energy, 32 (2007), p. 1121-1140.

Hydrogen storage (hydrogenation) can be effected at room temperature. Hydrogenation is an exothermic reaction. The heat of reaction that arises can be removed. By contrast, for the dehydrogenation, energy has to be supplied to the hydride in the form of heat. Dehydrogenation is an endothermic reaction.

For example, it may be the case that a low-temperature hydride is used together with a high-temperature hydride. For instance, in one configuration, it may be the case that, for example, the low-temperature hydride and the high-temperature hydride are provided in a mixture in a layer of a second region. It is also possible for these each to be arranged separately in different layers or regions, especially also in different second regions. For example, it may thus be the case that a first region is arranged between these second regions. In a further configuration, a first region has a mixture of low- and high-temperature hydride distributed in the matrix. It is also possible that different first regions include either a low-temperature hydride or a high-temperature hydride.

Preferably, the hydrogenatable material comprises a metal selected from magnesium, titanium, iron, nickel, manganese, nickel, lanthanum, zirconium, vanadium, chromium, or a mixture of two or more of these metals. The hydrogenatable material may also include a metal alloy comprising at least one of the metals mentioned.

More preferably, the hydrogenatable material (hydrogen storage material) comprises at least one metal alloy capable of storing hydrogen and releasing it again at a temperature of 150° C. or less, especially within a temperature range from −20° C. to 140° C., especially from 0° C. to 100° C. The at least one metal alloy here is preferably selected from an alloy of the AB₅ type, the AB type and/or the AB₂ type. A and B here each denote different metals, where A and/or B are especially selected from the group comprising magnesium, titanium, iron, nickel, manganese, nickel, lanthanum, zirconium, vanadium and chromium. The indices represent the stoichiometric ratio of the metals in the particular alloy. According to the invention, the alloys here may be doped with extraneous atoms. According to the invention, the doping level may be up to 50 atom %, especially up to 40 atom % or up to 35 atom %, preferably up to 30 atom % or up to 25 atom %, particularly up to 20 atom % or up to 15 atom %, preferably up to 10 atom % or up to 5 atom %, of A and/or B. The doping can be effected, for example, with magnesium, titanium, iron, nickel, manganese, nickel, lanthanum or other lanthanides, zirconium, vanadium and/or chromium. The doping can be effected here with one or more different extraneous atoms. Alloys of the AB₅ type are readily activatable, meaning that the conditions needed for activation are similar to those in the operation of the hydrogen storage means. They additionally have a higher ductility than alloys of the AB or AB₂ type. Alloys of the AB₂ or of the AB type, by contrast, have higher mechanical stability and hardness compared to alloys of the AB₅ type. Mention may be made here by way of example of FeTi as an alloy of the AB type, TiMn₂ as an alloy of the AB₂ type and LaNi₅ as an alloy of the AB₅ type.

More preferably, the hydrogenatable material (hydrogen storage material) comprises a mixture of at least two hydrogenatable alloys, at least one alloy being of the AB₅ type and the second alloy being an alloy of the AB type and/or the AB₂ type. The proportion of the alloy of the AB₅ type is especially 1% by weight to 50% by weight, especially 2% by weight to 40% by weight, more preferably 5% by weight to 30% by weight and particularly 5% by weight to 20% by weight, based on the total weight of the hydrogenatable material.

The hydrogenatable material (hydrogen storage material) is preferably in particulate form (particles).

The particles especially have a particle size x₅₀ of 20 μm to 700 μm, preferably of 25 μm to 500 μm, particularly of 30 μm to 400 μm, especially of 50 μm to 300 μm. x₅₀ means that 50% of the particles have a median particle size equal to or less than the value mentioned. The particle size was determined by means of laser diffraction, but can also be effected by sieve analysis, for example. The median particle size in the present case is the particle size based on weight, the particle size based on volume being the same in the present case. What is reported here is the particle size of the hydrogenatable material before it is subjected to hydrogenation for the first time. During the storage of hydrogen, stresses occur within the material, which can lead to a reduction in the x₅₀ particle size over several cycles.

Preferably, the hydrogenatable material is incorporated in the matrix to such a firm degree that it decreases in size on storage of hydrogen. Preference is therefore given to using, as hydrogenatable material, particulate material which breaks up while the matrix remains at least predominantly undestroyed. This result is surprising, since it was expected that the matrix would if anything tend to break up on expansion as a result of the increase in volume of the hydrogenatable material during the storage of hydrogen when there is high expansion because of the increase in volume. It is assumed at present that the outside forces acting on the particles, as a result of the binding within the matrix, when the volume increases, lead to particle breakup together with the stresses within the particles resulting from the increase in volume. Breakup of the particles was discovered particularly clearly on incorporation into polymer material in the matrix. The matrix composed of polymer material was capable of keeping the particles broken up in this way in a stable fixed position as well.

Tests have incidentally shown that, in the case of utilization of a binder, especially of an adhesive binder in the matrix for fixing of these particles, particularly good fixed positioning within the matrix is enabled. A binder content may preferably be between 2% by volume and 3% by volume of the matrix volume.

Preferably, there is a change in a particle size because of breakup of the particles resulting from the storage of hydrogen by a factor of 0.6, more preferably by a factor of 0.4, based on the x₅₀ particle size at the start and after 100 storage operations.

It has been found that, surprisingly, materials of this size exhibit particularly good properties in hydrogen storage. In the storage and release of hydrogen, there is expansion (in the course of hydrogenation) or shrinkage (in the course of dehydrogenation) of the material. This change in volume may be up to 30%. As a result, mechanical stresses occur in the particles of the hydrogenatable material, i.e. in the hydrogen storage material. In the course of repeated charging and discharging (hydrogenating and dehydrogenating) with hydrogen, it has been found that the particles break up. If the hydrogenatable material, then, in particular, has a particle size of less than 50 μm, particularly of less than 30 μm and especially of less than 25 μm, a finer powder can form during use, which may no longer be able to effectively store hydrogen. Moreover, there can be a change in the distribution of the material in the hydrogen storage means itself. Beds having particles of the material with very small diameters of a few nanometers can collect at the lowest point in the hydrogen storage means. In the case of charging with hydrogen (hydrogenation), high mechanical stresses at the walls of the hydrogen storage means occur at this point because of the expansion of the hydrogen storage material. Through the choice of suitable particle sizes for the material, it is possible to at least partly avoid this. On the other hand, a smaller particle size gives rise to a greater number of contact points where the particles interact with the matrix and adhere therein, such that an improved stability arises therefrom, which cannot be achieved in the case of particles having a size of more than 700 μm, especially of more than 500 μm.

The terms “material”, “hydrogenatable material” and “hydrogen storage material” are used synonymously in the present application, unless defined differently.

A further configuration envisages that the hydrogen storage means has a high-temperature hydride vessel and a low-temperature hydride vessel. The high-temperature hydrides may generate temperatures of more than 350° C., which have to be dissipated. This heat is released very rapidly and can be utilized, for example, for heating of a component associated with the hydrogen storage means. High-temperature hydrides utilized may, for example, be metal powders based on magnesium. The low-temperature hydride, by contrast, preferably has a temperature within a range preferably between −55° C. and 155° C., especially preferably within a temperature range between 80° C. and 140° C. A low-temperature hydride is, for example, Ti_{0.8}Zr_{0.2}CrMn or Ti_{0.98}Zr_{0.02}V_{0.43}Cr_{0.15}Mn_{1.2}. One configuration envisages transfer of hydrogen from the high-temperature hydride vessel to the low-temperature hydride vessel or vice versa, and storage therein in each case. By way of example and within the scope of the disclosure, reference is hereby made for this purpose to DE 36 39 545 C1.

With regard to hydrides and their properties, reference is made in the context of the disclosure of the invention to tables 1 to 4 in 3. Sakietuna et al., International Journal of Energy, 32 (2007), p. 1121-1140.

In the matrix, further components may be present as well as the at least one polymer. These components have principally at least one of the following functions: primary hydrogen storage, primary conduction of heat and/or primary conduction of gas. This is understood to mean that the respective component fulfills at least this function as its main object in the composite material. For instance, it is possible that a component is utilized primarily for hydrogen storage, but is simultaneously also capable of providing at least a certain conductivity of heat. In this case, however, there is at least one other component that assumes the primary function of conduction of heat, meaning that the greatest amount of heat is dissipated via the latter compared to the other components from the compressed material composite. In this case, it is again possible to utilize the primarily gas-conducting component, by means of which, for example, hydrogen (fluid) is guided into, but also, for example, guided out of, the material composite. In this case, the flowing fluid can also entrain heat. The flowing fluid in the context of the present invention is hydrogen or a gas mixture comprising hydrogen in a proportion of 50% by volume or more, preferably of 60% by volume or more, especially of 70% by volume or more, preferably of 80% by volume or more, particularly of 90% by volume or 95% by volume or more. Preferably, the hydrogenatable material stores exclusively hydrogen, such that, even in the case of use of gas mixtures as fluid, essentially only hydrogen is stored.

The hydrogen storage means preferably has at least 2, preferably more than 2, different layers, in which case one layer comprises the composite material and a different layer has at least one of the following functions: primary hydrogen storage, primary conduction of heat and/or primary conduction of gas.

What the term “layers” means is that a material is, or else two or more materials are, preferably arranged in a lamina and this can be delimited as a lamina from a direct environment. For example, different materials may be poured successively one on top of another in a loose arrangement, such that adjacent layers are in direct contact. In a preferred configuration, the hydrogenatable layer may be arranged directly adjacent to a thermally conductive layer, such that the heat which arises on absorption of hydrogen and/or release of hydrogen can be released from the hydrogenatable material directly to the adjacent layer.

The principal function of at least one of the following functions: primary hydrogen storage, primary heat conduction and/or primary gas conduction is understood to mean that the respective layer fulfills at least this function as a main object in the second region of the composite material. For instance, it is possible that a layer is utilized primarily for hydrogen storage, but is simultaneously also capable of providing thermal conductivity. In such a case, it is preferable that at least one other layer is present, which assumes the primary task of heat conduction, meaning that the greatest amount of heat is dissipated from the compressed material composite via this layer compared to other layers in the hydrogen storage means. In this case, in turn, it is possible to utilize the primarily gas-conducting layer, by means of which, for example, hydrogen (fluid) is passed into the material composite, or else, for example, is conducted out of it. In this case, heat can also be entrained by means of the fluid flowing through.

According to the invention, a heat-conducting layer may comprise at least one heat-conducting metal and/or graphite. These materials can also be used as heat-conducting component. The heat-conducting material is to have good thermal conductivity on the one hand, but secondly also a minimum weight, in order to minimize the total weight of the hydrogen storage means. The metal preferably has a thermal conductivity λ of 100 W/(m·K) or more, especially of 120 W/(m·K) or more, preferably of 180 W/(m·K) or more, particularly of 200 or more. According to the invention, the heat-conducting metal may also be a metal alloy or a mixture of different metals. The heat-conducting metal is preferably selected from silver, copper, gold, aluminum and mixtures of these metals or alloys comprising these metals. Particular preference is given to silver, since it has a very high thermal conductivity of more than 400 W/(m·K). Preference is likewise given to aluminum, since, as well as the high thermal conductivity of 236 W/(m·K), it has a low density and hence a low weight.

According to the invention, graphite comprises both expanded and unexpanded graphite. Preference is given to using expanded or expandable graphite. Alternatively, it is also possible to use carbon nanotubes (single-wall, double-wall or multiwall), since these likewise have very high thermal conductivity. Because of the high costs of the nanotubes, it is preferable to use expanded graphite or mixtures of expanded graphite and unexpanded graphite. If mixtures are present, based on weight, more unexpanded graphite is used than expanded graphite.

Natural graphite in ground form (unexpanded graphite) has poor adhesion in the composite material and can be processed to give a permanent, stable composite only with difficulty. Therefore, in the case of metal hydride-based hydrogen storage, preference is given to utilizing those graphite qualities that are based on expanded graphite. The latter is produced especially from natural graphite and has a much lower density than unexpanded graphite, but has good adhesion in the composite, such that a stable composite material can be obtained. If, however, exclusively expanded graphite in uncompacted form were to be used, the volume of the hydrogen storage means could become too great to be able to operate it economically. Therefore, preference is given to using mixtures of expanded and unexpanded graphite.

If the hydrogen storage material is compacted by means of pressing during production, expanded graphite forms an oriented layer which is able to conduct heat particularly efficiently. The graphite layers (hexagonal planes) in expanded graphite are shifted with respect to one another by the pressure on compression, such that lamellae or layers form. These hexagonal planes of graphite are then in a transverse arrangement (virtually at right angles with respect to the direction of pressure during an axial pressing operation), such that the hydrogen can then be introduced readily into the composite material and the heat can be conducted outward or inward efficiently. As a result, not just conduction of heat but also conduction of gas or conduction of fluid can be enabled.

Alternatively, the expanded graphite can be processed, for example, by means of calender rolling to give films. These films are then ground again. The flakes thus obtained can then be used as heat-conducting material. The rolling gives rise to a preferential direction in the carbon lattice here too, as a result of which particularly good onward conduction of heat and fluid is enabled.

Preference is given to using graphite as heat-conducting material, for example when a high-temperature hydride is present as hydrogenatable material in the material composite. In the case of low-temperature hydrides, preference is given to a heat-conducting metal, especially aluminum. This combination is preferred especially when the two layers directly adjoin one another. According to the invention, it is possible, for example, that a first layer which constitutes the first region, the material composite of the invention comprising a high-temperature hydride, directly adjoins a second layer comprising graphite. This second layer may then in turn directly adjoin a third layer comprising a heat-conducting metal, which then again adjoins a fourth layer comprising graphite. This fourth layer may then again be adjoined directly by a first layer comprising the material composite. Any desired layer sequences are possible in accordance with the invention. In the context of the present invention, “comprise” means that not only the materials mentioned but also further constituents may be present; preferably, however, “comprise” means “consist of”.

Graphite and/or aluminum and/or other heat-conducting metals may take the form of granules, of powder or of a sheet or film. A sheet or film may already constitute a layer in the context of the present invention. However, it is also conceivable that 3-dimensional configurations are present, which form a layer which penetrates at least partly into the layer of the material composite, as a result of which it is possible to enable better removal and supply of heat. In particular, graphite, as well as thermal conductivity, also has good conduction of gas. However, aluminum has the better thermal conductivity compared to graphite.

For conduction of gas, the hydrogen storage means preferably has a porous layer. This may, for example, be a heat conduction layer comprising graphite, as described further up. According to the invention, a porous layer may also be a porous region in which the heat-conducting metal or else the hydrogenatable material is not densely compressed, such that conduction of gas (conduction of fluid) is readily possible.

In addition, at least one component of the composite material, for example one or more intermediate layers of aluminum, may have been produced in a sintering process. In a sintering process, fine-grain, usually ceramic or metallic substances are heated, but the temperatures usually remain below the melting temperature of the main components, such that the shape of the workpiece is conserved. There is generally only very slight shrinkage of a few tenths of a millimeter, if any. In addition, it is possible to make a selection of material such that the particles of the starting material increase in density and pore spaces are filled. A basic distinction is made between solid phase sintering and liquid phase sintering, in which there is also melting. The thermal treatment of sintering converts a fine- or coarse-grain green body which has been formed in a preceding process step, for example by means of extrusion, to a solid workpiece. It is only as a result of the thermal treatment that the sintering product receives its ultimate properties, such as hardness, strength or thermal conductivity, which are required in the particular use. For example, it is possible in this way to create an open-pore matrix into which the hydrogenatable material is admitted. It is also possible in this way to create channel structures which, for example, are gas-conducting and are used in the hydrogen storage means.

It is preferable that the hydrogenatable material preferably has a proportion of greater than 50% to 98% by volume and the matrix preferably has a proportion of at least 2% to 50% by volume of the composite material. The proportion of the percentage by volume of the hydrogenatable material and the matrix can be determined by known test methods and detection methods, for example with the aid of a scanning electron microscope. It is likewise possible to use a light microscope. Preference is given to using an imaging program, with automatic evaluation by means of a computer program.

The matrix may additionally include different carbon polymorphs. The use of different carbon polymorphs can improve the thermal conductivity of the hydrogen storage means. In this way, it is possible to better dissipate the heat that arises on absorption and/or release of the hydrogen.

It is preferable that the matrix and/or a layer includes a mixture of different carbon polymorphs comprising, for example, expanded natural graphite as one of the carbon polymorphs. Preference is given to using unexpanded graphite together with expanded natural graphite, in which case more unexpanded graphite than expanded graphite is used on the basis of weight. More particularly, the matrix may include expanded natural graphite with, for example, a hydrogenatable material arranged therein. Further carbon polymorphs include, for example, single-wall, double-wall or multiwall nanotubes, graphenes and fullerenes.

It is preferable that the matrix comprises expanded natural graphite with a proportion by weight of 1% to 20% by weight in the composite material.

In a preferred embodiment, the proportion of the respective components varies over the length of the composite material. The varying proportion may take the form of a monotonous or non-monotonous gradient or the form of a step function. As a result, it is possible to implement a gradient or a rise in the hydrogenatable material in the matrix. In this way, it is possible to adjust the structure of the matrix, for example depending on the fluid that flows through the hydrogen storage means.

In addition, the matrix may additionally include carbon polymorphs in the form of short fibers. In this way, it is possible to compensate for a change in length. In addition, the use of fibers enables improved stability of the matrix.

Preferably, the composite material has a porous matrix. In one configuration, a porous matrix can ensure that the matrix is not damaged by an expansion in volume of the hydrogenatable material.

Preferably, the matrix has an expansion property, preferably an elastic property, in at least one region. In this way, it is possible to ensure that, for example, on absorption of hydrogen, the hydrogenatable material can expand without damaging or overstressing the composite material. As a result of the absorption of hydrogen, for example, the hydrogenatable material can expand, such that there is a positive change in volume (contraction). On release of hydrogen, the hydrogenatable material can contract, such that there is a negative expansion in volume or contraction. By virtue of an expansion property, preferably elastic property, in at least one region, the matrix can follow at least the expansion in volume of the hydrogenatable material, such that no damage to the matrix occurs.

In a preferred configuration, the hydrogenatable material has a coating. The coating can additionally enable properties in the hydrogenatable material. For example, the coating may be a polymer and the coating may improve the conduction of gas and thermal conductivity of the hydrogenatable material. The coating may include the same polymers that also form the matrix. However, it is also possible to use different polymers for coating and matrix. The coating of the material can ensure that the hydrogen is stored in the material, with simultaneous prevention or at least reduction of weakening of the material as a result of oxidation, for example. Oxidation of the material would lead to formation of a layer at the surface through which hydrogen can penetrate only with great difficulty, if at all. Thus, the rate at which hydrogenation and dehydrogenation take place is distinctly reduced. However, this rate should be at a maximum in order to enable economically viable use. In addition, the regions of the material that have been oxidized are no longer available for hydrogen storage, such that the amount of hydrogen which can be stored by the material, i.e. the hydrogen storage capacity, is reduced. However, specifically the hydrogen storage capacity should be at a maximum in order to enable economically viable use.

The oxidation protection layer that arises as a result of the coating now enables use of the hydrogen storage material over a large number of cycles without significant impairment of the storage capacity of the material, which can enable a long lifetime of the hydrogen storage means.

It is preferable that the composite material has been compacted. The compaction can be effected, for example, by compression. The compression can be effected, for example, with the aid of an upper ram and a lower ram by pressure (axial pressing). In addition, the compression can be effected via isostatic pressing. The isostatic press method is based on the physical law that pressure in liquids and gases propagates uniformly in all directions and generates forces on the surfaces subjected thereto that are directly proportional to these areas. The first and second regions can be introduced into the pressure vessel of a pressing system, for example, in a rubber mold. The pressure that acts on the rubber mold on all sides via the liquid in the pressure vessel compresses the enclosed first and second regions in a uniform manner. It is also possible to insert a preform comprising the first and second regions into the isostatic press, for example into a liquid. By applying high pressures, preferably within a range from 500 to 6000 bar, the composite material can be produced. The high pressures in isostatic pressing permit, for example, the creation of new material properties in the composite material.

In a preferred embodiment, the composite material has been compacted by at least 20% of its maximum compaction up to a maximum of 92.36% of its maximum compaction. A mixed density can be provided in this way.

Preferably, the latter has regions having a different principal function, comprising each of at least one gas-permeable region, a heat-conducting region and a hydrogen-storing region.

It is preferable that a plurality of hydrogen storage means with small housings can be joined to one another. In this way, it is possible to achieve a good outcome in hydrogen absorption and/or release.

The invention further relates to a process for producing a hydrogen storage means comprising a hydrogenatable material and a matrix. The matrix preferably includes different carbon polymorphs as well as the polymer. The hydrogenatable material is incorporated into this matrix, and then a composite material that stores hydrogen is formed.

It is preferable that the hydrogenatable material and also the respective carbon is supplied in individualized form in each case, especially in the form of particles or flakes, and compressed to form the composite material. It is preferable that the matrix comprises a mixture of different carbon polymorphs, comprising, for example, expanded natural graphite as one of the carbon polymorphs. Preference is given to using unexpanded graphite together with expanded natural graphite, in which case more unexpanded graphite than expanded graphite is used on the basis of weight. More particularly, the matrix may include expanded natural graphite with a hydrogenatable material, for example, arranged therein. Further carbon polymorphs include, for example, single-wall, double-wall or multiwall nanotubes, graphenes and also fullerenes.

In a preferred embodiment, a controlled arrangement of matrix and hydrogenatable material is effected in a pressing apparatus for formation of principally gas-permeable regions, heat-conducting regions and hydrogen-storing regions in the hydrogen storage means.

Preference is given to using exclusively a matrix material in the hydrogen storage means as hydrogenatable component. In a further configuration, a matrix material is used predominantly, i.e. to an extent of at least 50% by weight of the hydrogenatable components, in a hydrogen storage means. In a further configuration, this proportion is more than 80% by weight, preferably more than 90% by weight, especially at least approximately 100% by weight. Another hydrogenatable component may otherwise, for example, be a layer material.

The invention further relates to an apparatus for producing a hydrogen storage means, preferably an above-described hydrogen storage means, more preferably by an above-described process, wherein the apparatus has a cavity into which at least one individualized material of the hydrogen storage means is introduced, preferably in the form of a pourable pulverulent material, with provision of a mixer, by means of which a first and a different, second carbon polymorph are miscible, and additionally a first feed for the first carbon polymorph and a second feed for the second carbon polymorph and a feed for the hydrogenatable material.

Further advantageous configurations and also features are apparent from the FIGURES which follow and the corresponding description. The individual features that are apparent from the figures and the description are merely illustrative and not restricted to the particular configuration. Instead, one or more features from one or more FIGURES can be combined with other features from other FIGURES and also from the above description to give further configurations. Therefore, the features are specified not in a restrictive manner but merely by way of example.

The FIGURE shows:

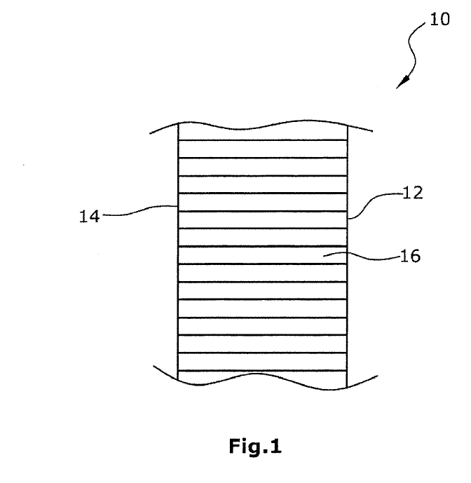

FIG. 1 a detail from a hydrogen storage means.

FIG. 1 shows a detail of a hydrogen storage means 10. The hydrogen storage means 10 has two outer walls 12, 14 between which a multitude of matrices 16 are arranged. The hydrogenatable material is embedded in the matrices 16. The matrices 16 together with the hydrogenatable material form a composite material. The hydrogenatable material is a metal alloy and has a proportion in the composite material of 50% to 98% by volume. The matrix 16 includes various carbon polymorphs, for example expanded natural graphite and unexpanded graphite, and has a proportion in the composite material of 20% to 50% by volume. The expanded natural graphite of the matrix 16 has a proportion by weight of 1% to 20% by weight of the composite material. The proportion of the respective component varies over the length of the composite material. The hydrogenatable material is embedded in the matrix 16. The composite material has been compacted, for example, to an extent of 70% of its maximum compaction by compression.

The following points 1 to 14 summarize further essential features of the present invention:

1. A hydrogen storage means comprising a hydrogenatable material and a matrix into which the hydrogenatable material has been embedded and forms a composite material with the matrix.

2. The hydrogen storage means according to point 1, wherein the hydrogenatable material preferably has a proportion of greater than 50% to 98% by volume and the matrix preferably has a proportion of at least 2% to 50% by volume of the composite material, the matrix comprising different carbon polymorphs.

3. The hydrogen storage means according to point 1 or 2, characterized in that the matrix comprises expanded natural graphite.

4. The hydrogen storage means according to any of the preceding points, characterized in that the matrix comprises unexpanded graphite.

5. The hydrogen storage means according to any of the preceding points, characterized in that the matrix comprises expanded natural graphite with a proportion by weight of 1% to 20% by weight of the composite material.

6. The hydrogen storage means according to any of the preceding points, characterized in that the proportion of the particular components varies over the length of the composite material.

7. The hydrogen storage means according to any of the preceding points, characterized in that the composite material has a porous matrix essentially composed of carbon into which the hydrogenatable material has been embedded.

8. The hydrogen storage means according to any of the preceding points, characterized in that the composite material has been compacted, the composite material preferably comprising a matrix composed of polymer combined with graphite.

9. The hydrogen storage means according to any of the preceding points, characterized in that the composite material has been compacted by at least 20% of its maximum compaction up to a maximum of 92.36% of its maximum compaction.

10. The hydrogen storage means according to any of the preceding points, characterized in that it has regions having a different principal function, comprising each of at least a gas-permeable region, a heat-conducting region and a hydrogen-storing region.

11. A process for producing a hydrogen storage means comprising a hydrogenatable material and a matrix, wherein the matrix is produced by means of different carbon polymorphs and the hydrogenatable material is incorporated into this matrix, and then a composite material that stores hydrogen is formed.

12. The process according to point 11, characterized in that the hydrogenatable material and also the particular carbon are each supplied in individualized form, especially as particles or flakes, and compressed to give the composite material.

13. The process according to point 11 or 12, characterized in that a controlled arrangement of matrix and hydrogenatable material is effected in a pressing apparatus for formation of principally gas-permeable regions, heat-conducting regions and hydrogen-storing regions in the hydrogen storage means.

14. An apparatus for producing a hydrogen storage means, preferably a hydrogen storage means according to any of points 1 to 10, more preferably by a process with the features of points 11 to 13, wherein the apparatus has a cavity into which at least one individualized material of the hydrogen storage means is introduced, preferably in the form of a pourable pulverulent material, with provision of a mixer, by means of which a first and a different, second carbon polymorph are miscible, and additionally a first feed for the first carbon polymorph and a second feed for the second carbon polymorph and a feed for the hydrogenatable metal.

1. A hydrogen storage means comprising a hydrogenatable material and a matrix comprising at least one polymer.

2. The hydrogen storage means as claimed in claim 1, wherein the hydrogenatable material preferably has a proportion of greater than 50% to 98% by volume and the matrix preferably has a proportion of at least 2% to 50% by volume of the composite material.

3. The hydrogen storage means as claimed in claim 1, wherein the polymer has a density in the range from 0.7 g/cm³ to 1.3 g/cm³, especially of 0.8 g/cm³ to 1.25 g/cm³.

4. The hydrogen storage means as claimed in claim 1, wherein the polymer has a tensile strength in the range from 10 MPa to 100 MPa, especially from 15 MPa to 90 MPa.

5. The hydrogen storage means as claimed in claim 1, wherein the polymer is selected from the group comprising EVA, PMMA, EEAMA and mixtures of these polymers.

6. The hydrogen storage means as claimed in claim 1, wherein the matrix further includes different carbon polymorphs, the matrix further including expanded natural graphite and/or unexpanded graphite.

7. The hydrogen storage means as claimed in claim 1, wherein the matrix includes a heat-conducting metallic material for formation of a heat-dissipating compound.

8. The hydrogen storage means as claimed in claim 1, wherein the proportion of the respective components varies over the length of the composite material comprising the matrix and the hydrogenatable material.

9. The hydrogen storage means as claimed in claim 1, wherein the composite material has been compacted.

10. The hydrogen storage means as claimed in claim 1, wherein the composite material has been compacted by at least 20% of its maximum compaction up to a maximum of 92.36% of its maximum compaction.

11. The hydrogen storage means as claimed in claim 1, wherein it has regions having a different principal function, comprising each of at least a gas-permeable region, a heat-conducting region and/or a hydrogen-storing region.

12. A process for producing a hydrogen storage means comprising a hydrogenatable material and a matrix, wherein the matrix comprises a polymer and the hydrogenatable material is incorporated into this matrix, and then a composite material that stores hydrogen is formed.

13. The process as claimed in claim 12, wherein a controlled arrangement of matrix and hydrogenatable material is effected in a pressing apparatus for formation of principally gas-permeable regions, heat-conducting regions and hydrogen-storing regions in the hydrogen storage means.

14. The process as claimed in claim 12, wherein the hydrogenatable material has already at least once absorbed hydrogen for storage before it is incorporated into the matrix.

15. The process as claimed in claim 1, wherein the hydrogenatable material, firmly incorporated in the matrix, decreases in size on storage of hydrogen, especially with breakup of particles of the hydrogenatable material, while the matrix remains at least predominantly undestroyed.

16. An apparatus for producing a hydrogen storage means, as claimed in claim 1, wherein the matrix comprises a polymer and the hydrogenatable material is incorporated into this matrix, and then a composite material that stores hydrogen is formed, wherein the apparatus has a cavity into which at least one individualized material of the hydrogen storage means is introduced in the form of a pourable pulverulent material, with provision of a mixer, by means of which a first and a different, second carbon polymorph are miscible, and additionally a first feed for the first carbon polymorph and a second feed for the second carbon polymorph and a feed for the hydrogenatable metal and for a polymer.

17. An apparatus for producing a hydrogen storage means, as claimed in claim 1, wherein the hydrogenatable material, firmly incorporated in the matrix, decreases in size on storage of hydrogen, especially with breakup of particles of the hydrogenatable material, while the matrix remains at least predominantly undestroyed, wherein the apparatus has a cavity into which at least one individualized material of the hydrogen storage means is introduced in the form of a pourable pulverulent material, with provision of a mixer, by means of which a first and a different, second carbon polymorph are miscible, and additionally a first feed for the first carbon polymorph and a second feed for the second carbon polymorph and a feed for the hydrogenatable metal and for a polymer.
